(19) United States
(12) Patent Application Publication
(10) Pub. No.: US 2025/0126525 A1
(43) Pub. Date: Apr. 17, 2025

(54) COORDINATION OF USER EQUIPMENT CONTEXT INFORMATION BETWEEN RADIO ACCESS NODES

(71) Applicant: Nokia Technologies Oy, Espoo (FI)

(72) Inventors: Navin HATHIRAMANI, Dallas, TX (US); John HARRIS, Whitefish Bay, WI (US); Gagandeep BHATTI, Dallas, TX (US)

(21) Appl. No.: 18/887,139

(22) Filed: Sep. 17, 2024

(30) Foreign Application Priority Data
Sep. 1, 2023 (GB) 2314449.6

(51) Int. Cl. H04W 36/00

(52) U.S. Cl. CPC H04W 36/0033; H04W 36/0079

(57) ABSTRACT

A method is provided that comprises providing a radio network service to at least one user equipment by a serving radio access node having context information in association with the at least one user equipment. The method comprises determining to shut down the radio network service. The context information is forwarded by the serving radio access node to a plurality of radio access nodes within reach, via a signaling procedure defined as a non-acknowledgement message procedure, for the plurality of radio access nodes to store the context information for enabling a continued radio network service to the at least one user equipment. And a mobility management function is informed of the determined shut down along with an indication of the plurality of radio access nodes for the mobility management function informing at least one candidate node for providing the continued radio network service of the plurality of radio access nodes.

### TECHNOLOGICAL FIELD

The present disclosure relates generally to telecommunications and, in particular, to coordination of user equipment context information between radio access nodes.

### BACKGROUND

A telecommunications system can be seen as a facility that enables communication sessions between two or more entities such as user terminals, base stations and/or other nodes by providing carriers between the various entities involved in the communications path. A telecommunications system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless telecommunications system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the telecommunications system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The telecommunications system and associated devices typically operate in accordance with a given standard or specification which sets out what the various entities associated with the system are permitted to do and how that should be achieved. Communication protocols and/or parameters which shall be used for the connection are also typically defined. One example of a telecommunications system is the Universal Mobile Telecommunications System (UMTS). Other examples of telecommunications systems are Long-Term Evolution (LTE), LTE Advanced and the so-called 5G or New Radio (NR) networks. NR is being standardized by the 3rd Generation Partnership Project (3GPP).

### BRIEF DESCRIPTION

Example implementations of the present disclosure are directed to telecommunications and, in particular, to coordination of user equipment (UE) context information between radio access nodes, such as for network energy savings. According to example implementations, a serving radio access node may forward UE context information for UE(s) served by the serving radio access node to a plurality of radio access nodes within reach, in advance of a determined shutdown at the serving radio access node, such as for network energy savings. A new serving radio access node may then retrieve the UE context information from at least one of the radio access node(s) to enable a continued radio network service to the UE(s).

The present disclosure thus comprises, without limitation, the following example implementations.

Some example implementations provide an apparatus comprising: means for providing a radio network service to at least one user equipment by a serving radio access node having context information in association with the at least one user equipment; means for determining to shut down the radio network service; means for forwarding the context information by the serving radio access node to a plurality of radio access nodes within reach, via a signaling procedure defined as a non-acknowledgement message procedure, for the plurality of radio access nodes to store the context information for enabling a continued radio network service to the at least one user equipment; and means for informing a mobility management function of the determined shut down along with an indication of the plurality of radio access nodes for the mobility management function informing at least one candidate node for providing the continued radio network service of the plurality of radio access nodes.

Some example implementations provide a method comprising: providing a radio network service to at least one user equipment by a serving radio access node having context information in association with the at least one user equipment; determining to shut down the radio network service; forwarding the context information by the serving radio access node to a plurality of radio access nodes within reach, via a signaling procedure defined as a non-acknowledgement message procedure, for the plurality of radio access nodes to store the context information for enabling a continued radio network service to the at least one user equipment; and informing a mobility management function of the determined shut down along with an indication of the plurality of radio access nodes for the mobility management function informing at least one candidate node for providing the continued radio network service of the plurality of radio access nodes.

Some example implementations provide an apparatus comprising: means for receiving information, via a signaling procedure defined as a non-acknowledgement message procedure, indicating a plurality of radio access nodes storing context information in association with at least one user equipment for enabling a continued radio network service for the at least one user equipment when a radio network service shut down is carried out by a serving radio access node; means for receiving a request from at least some of the at least one user equipment to provide the continued radio network service, wherein the request comprises an identifier of the serving radio access node; means for retrieving, based on the identifier, the context information from at least one of the plurality of radio access nodes, and means for providing the continued radio network service to the at least some of the at least one user equipment.

Some example implementations provide a method comprising: receiving information, via a signaling procedure defined as a non-acknowledgement message procedure, indicating a plurality of radio access nodes storing context information in association with at least one user equipment for enabling a continued radio network service for the at least one user equipment when a radio network service shut down is carried out by a serving radio access node; receiving a request from at least some of the at least one user equipment to provide the continued radio network service, wherein the request comprises an identifier of the serving radio access node; retrieving, based on the identifier, the context information from at least one of the plurality of radio access nodes; and providing the continued radio network service to the at least some of the at least one user equipment.

These and other features, aspects, and advantages of the present disclosure will be apparent from a reading of the following detailed description together with the accompanying figures, which are briefly described below. The present disclosure comprises any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable unless the context of the disclosure clearly dictates otherwise.

It will therefore be appreciated that this Brief Description is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE(S)

Having thus described example implementations of the disclosure in general terms, reference will now be made to the accompanying figures, which are not necessarily drawn to scale, and wherein:

FIG. 1 illustrates a telecommunications system that comprises one or more public land mobile networks (PLMNs) coupled to one or more external data networks, according to some example implementations of the present disclosure;

FIG. 2 illustrates a deployment of a PLMN, according to some example implementations;

FIG. 3 illustrates a deployment of a PLMN in which a cell of a serving radio access node is to shut down, such as for a network energy savings event, according to some example implementations;

FIG. 4 is a signaling chart for coordination of UE context information between radio access nodes, according to some example implementations;

FIGS. 5A, 5B and 5C are flowcharts illustrating various steps in a method that may be implemented at a serving radio access node, according to various example implementations;

FIGS. 6A and 6B are flowcharts illustrating various steps in a method that may be implemented at a new serving radio access node, according to various example implementations; and

FIGS. 7, 8 and 9 illustrate apparatuses according to various example implementations.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true. Further, the articles “a” and “an” mean “one or more,” unless specified otherwise or clear from context to be directed to a singular form. Furthermore, it should be understood that unless otherwise specified, the terms “data,” “content,” “digital content,” “information,” and similar terms may be at times used interchangeably. The term “network” may refer to a group of interconnected computers comprising clients and servers; and within a network, these computers may be interconnected directly or indirectly by various means, such as via one or more switches, routers, gateways, access points or the like.

Reference may be made herein to terms specific to a particular system, architecture or the like, but it should be understood that example implementations of the present disclosure may be equally applicable to any of a number of systems, architectures and the like. For example, reference may be made to 3GPP technologies such as Global System for Mobile Communications (GSM), UMTS, LTE, LTE Advanced, 5G NR, 5G Advanced, and 6G; however, it should be understood that example implementations of the present disclosure may be equally applicable to non-3GPP technologies such as IEEE 802, Bluetooth and Bluetooth Low Energy.

Further, as used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (comprising digital signal processor(s)), software, and memory(ies) that work together to cause an apparatus, such as a mobile phone or server, to perform various functions); or (c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

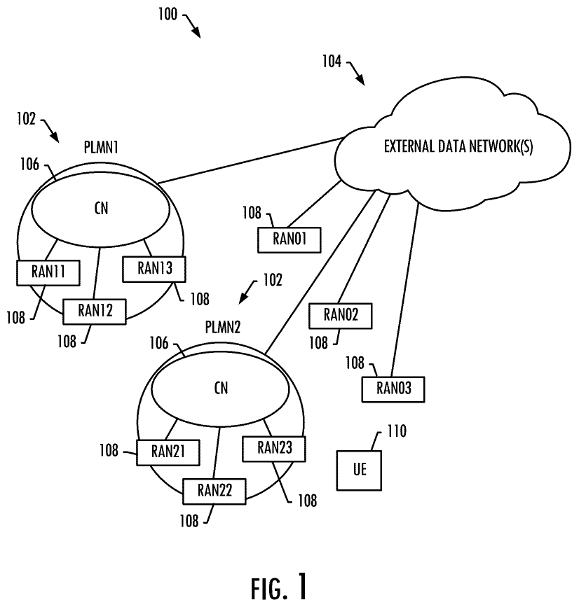

FIG. 1 illustrates a telecommunications system 100 according to various example implementations of the present disclosure. The telecommunications system generally comprises one or more telecommunications networks. As shown, for example, the system comprises one or more public land mobile networks (PLMNs) 102 coupled to one or more other external data networks 104-notably comprising a wide area network (WAN) such as the Internet. Each of the PLMNs comprises a core network (CN) 106 backbone such as the Evolved Packet Core (EPC) of LTE, the 5G core network (5GC) or the like; and each of the core networks and the Internet are coupled to one or more radio access networks (RANs) 108, air interfaces or the like that implement one or more radio access technologies (RATs). As used herein, a “network device” refers to any suitable device at a network side of a telecommunications network. Examples of suitable network devices are described in greater detail below.

In addition, the system comprises one or more radio units that may be varyingly known as user equipment (UE) 110, terminal device, terminal equipment, mobile station or the like. The UE is generally a device configured to communicate with a network device or a further UE in a telecommunication network. The UE may be a portable computer (e.g., laptop, notebook, tablet computer), mobile phone (e.g., cell phone, smartphone), wearable computer (e.g., smartwatch), or the like. In other examples, the UE may be an Internet of things (IoT) device, an industrial IoT (IIoT device), a vehicle equipped with a vehicle-to-everything (V2X) communication technology, or the like. In operation, these UEs may be configured to connect to one or more of the RANs 108 according to their particular radio access technologies to thereby access a particular CN 106 of a PLMN 102, or to access one or more of the external data networks 104 (e.g., the Internet). The external data network may be configured to provide Internet access, operator services, 3rd party services, etc. For example, the International Telecommunication Union (ITU) has classified 5G mobile network services into three categories: enhanced mobile broadband (eMBB), ultra-reliable and low-latency communications (URLLC), and massive machine type communications (mMTC) or massive internet of things (MIOT).

Examples of radio access technologies comprise 3GPP radio access technologies such as GSM, UMTS, LTE, LTE Advanced, 5G NR, 5G Advanced, and 6G. Other examples of radio access technologies comprise IEEE 802 technologies such as IEEE 802.11 (Wi-Fi), IEEE 802.15 (e.g., 802.15.1 (WPAN/Bluetooth), 802.15.4 (Zigbee) and 802.15.6 (WBAN)), Bluetooth, Bluetooth Low Energy (BLE), ultra wideband (UWB), and the like. Generally, a radio access technology may refer to any 2G, 3G, 4G, 5G, 6G or higher generation mobile communication technology and their different versions, as well as to any other wireless radio access technology that may be arranged to interwork with such a mobile communication technology to provide access to the CN 106 of a mobile network operator (MNO).

In various example, a RAN 108 may be configured as one or more cells, such as macrocells, microcells, picocells, femtocells or the like. The RAN may generally comprise one or more radio access nodes (at times more simply referred to as a “node”) that are configured to provide cells to interact with UEs 110. In various examples, a radio access node may be referred to as a base station (BS), access point (AP), base transceiver station (BTS), Node B (NB), evolved NB (eNB), macro BS, NB (MNB) or eNB (MeNB), home BS, NB (HNB) or eNB (HeNB), next generation NB (gNB), enhanced gNB (en-gNB), next generation eNB (ng-eNB), or the like. Some type of network controlling/governing entity responsible for control of the radio access nodes. The network controlling/governing entity and radio access node may be separate or integrated into a single apparatus. The network controlling/governing entity may comprise processing circuitry configured to carry out various management functions, etc. The processing circuitry may be associated with a computer-readable storage medium or database for maintaining information required in the management functions.

A RAN 108 may be centralized or distributed. In various examples, components of a RAN may be interconnected by Ethernet, Gigabit Ethernet, Asynchronous Transfer Mode (ATM), optical fiber, dark fiber, passive wavelength division multiplexing (WDM), WDM passive optical network (WDM-PON), optical transport network (OTN), time sensitive networking (TSN) and/or any other data link layer network, possibly comprising radio links. The RAN may be connected to a CN 106 through one or more gateways, network functions or the like.

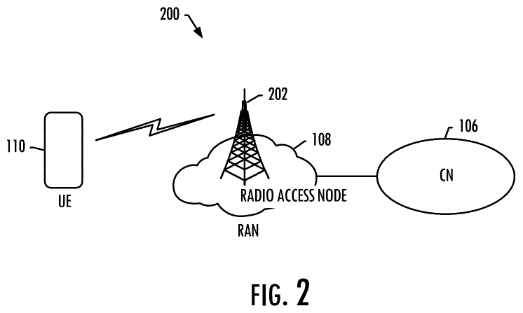

As will be appreciated, a PLMN 102 may be deployed in a number of different manners. FIG. 2 illustrates a deployment 200 of a PLMN, such as a 4G LTE or 5G deployment, according to some example implementations. As shown, the deployment comprises a CN 106, and RAN 108 with one or more radio access nodes 202 configured to interact with UEs 110. In a 4G LTE deployment, the EPC is the CN, and the evolved UMTS terrestrial radio access network (E-UTRAN) is the RAN; and the E-UTRAN comprises one or more eNBs (radio access nodes) configured connect UEs to the E-UTRAN to thereby access the EPC. Similarly, in a 5G deployment, the 5GC is the CN 106, and the next generation (NG) radio access network (NG-RAN) is the RAN 108; and the NG-RAN comprises one or more gNBs (radio access nodes 202) configured connect UEs 110 to the NG-RAN to thereby access the 5GC. The term ‘gNB’ in 5G may correspond to the eNB in 4G LTE.

Some deployments of 4G LTE and 5G in particular are considered standalone (SA) deployments. Other deployments combine 4G LTE and 5G technologies, and are referred to as non-standalone (NSA) deployments. In some deployments, the E-UTRAN comprises one or more ng-eNBs that are configured to communicate with the 5GC, and that may also be configured to communicate with one or more gNBs. Similarly, in another deployment, the NG-RAN may comprise one or more en-gNBs that are configured to communicate with the EPC, and that may also be configured to communicate with one or more eNBs. In various instances, a single UE 110, a dual-mode or multimode UE, may support multiple (two or more) RANs-thereby being configured to connect to multiple RANs, such as 4G LTE and 5G.

In some deployments, operations of a radio access node 202 may be distributed or functionally split into components comprising one or more remote radio head (RRHs) or radio units (RUs), and a baseband unit (BBU); and in some architectures, the BBU may be split into a distributed unit (DU) and a central/centralized unit (CU), such as a server, host or node. In some architectures, the RRH/RU and DU may be collocated. It is also possible that node operations may be distributed among a plurality of servers, hosts or nodes.

It should also be understood that the distribution of work between CN 106 operations and radio access node 202 operations may vary depending on implementation. Thus, a 5G network architecture may be based on a so-called CU-DU split. One gNB-CU (central node) may control one or more gNB-DUs. The gNB-CU may control a plurality of spatially separated gNB-DUs, acting at least as transmit/receive (Tx/Rx) nodes. In some example implementations, however, the gNB-DUs (also called DU) may comprise, for example, a radio link control (RLC), medium access control (MAC) layer and a physical (PHY) layer, whereas the gNB-CU (also called a CU) may comprise the layers above the RLC layer, such as a packet data convergence protocol (PDCP) layer, a radio resource control (RRC), and an internet protocol (IP) layer. Other functional splits are also possible. It is considered that skilled person is familiar with the OSI model and the functionalities within each layer.

In some example implementations, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU, and the boundary where the responsibility is shifted between the CU and the DU may be selected according to implementation.

Although only one radio access node 202 is shown in FIG. 2, the deployment may comprise multiple radio access nodes, and at least some of the radio access nodes may be connected to one another by a network interface, such as an Xn interface. Similarly, the radio access nodes may be connected to the CN 106 by a network interface. In 5G NR, the network interface between a radio access node and the CN is referred to as the NG interface, which is a network interface between the radio access node and an access and mobility management function (AMF) of the 5GC. These network interfaces may support various procedures, which may be classified into class 1 defined as an acknowledgement (ACK/NACK) message procedure, or class 2 defined as a non-acknowledgement message procedure. In some examples described below, a class 1 message procedure where an acknowledgement is not required may also be defined as a non-acknowledgement message procedure.

The network interface between the radio access node 202 and the CN 106 may support the exchange of signaling messages between the RAN 108 and the CN. The signaling messages may be formatted according to an application layer protocol, such as the NG application protocol (NGAP) for the NG interface. The NGAP supports a number of procedures, comprising elementary procedures, such as to establish, maintain or release the RAN part of a communication session between a UE 110 and external data network 104 (referred to in 5G NR as a packet data unit (PDU) session), perform handover of a UE, and the like.

When a connection (e.g., RRC connection) is setup between a UE 110 and a cell of a radio access node 202 serving the UE, an initial context setup procedure may be performed to establish a UE context at the serving radio access node. The UE context generally comprises context information in association with the UE (at times referred to as UE context information), which may be used by the serving radio access node to maintain a radio network service provided by the serving radio access node towards the UE. The UE context information may comprise, for example, PDU session context, security key(s), mobility restriction list, UE radio capability, UE security capabilities, and the like.

During a handover event, the UE context may be transferred from the serving radio access node to a new serving radio access node other than the serving radio access node. If a UE 110 experiences radio link failure (RLF) with its serving radio access node, the UE may attempt to re-establish its connection in a cell of a new serving radio access node. Similarly, a UE in an inactive state may attempt to resume its connection with a new serving radio access node. In these cases, the UE may identify its last serving radio access node to the new serving radio access node, and the new serving radio access node may attempt to retrieve the UE context from the last serving radio access node (e.g., over the Xn interface) to facilitate minimal end user interruption.

An area of focus in networks, such as 5G networks, is network energy savings, such as at the RAN 108 which consumes a significant amount of the total energy consumption in the PLMN. Current efforts aim to identify adaptation techniques of transmissions and/or receptions in time, frequency, spatial, and power domains, with potential support/feedback from the UE 110, potential UE assistance information, and information exchange/coordination over network interfaces. Discontinuous transmission (DTX) is a promising solution to save network energy by switching radio units (e.g., power amplifier) on and off based on whether a transmission is to be made.

With dynamic network energy savings (NES), one or more radio access nodes 202 may enter and exit an NES state, such as a sleep state, which may present a need for a UE 110 receiving radio network services from a cell of one radio access node to switch to a cell of another radio access node, after the one radio access node makes an NES state change (e.g., enter/exit a sleep state). This may be the case for UEs in a connected state (e.g., RRC connected) or an inactive state (e.g., RRC inactive). Radio access nodes transitioning into and out of NES states may impact network key performance indicators (KPIs) such as dropped call rates and call interruption times, and thereby impact end users. It may therefore also be desirable for the UE to switch cells of respective radio access nodes with low impact on the end user experience in a way that enables NES features to be frequently (and even briefly) leveraged (turned on to save energy) to promote their adoption by MNOs.

When an NES event is triggered at a radio access node 202, UE(s) 110 served by cell(s) of a radio access node may connect to cell(s) of other radio access node(s). This may be facilitated by a graceful shutdown procedure where a cell shutting down gradually reduces its transmission power so that the UE will trigger a handover to a neighboring cell. Although the graceful shutdown procedure reduces end user impact, the procedure may also require a long time window, e.g., 300 seconds. The additional delay from the graceful shutdown procedure may in turn reduce energy savings due to a reduction in the time period for the NES event, and because a predicted duration of time in a sleep state may be larger than the time required to transition in/out of NES.

Another solution could be based on aborting cell transmissions and letting the UE re-establish in neighboring cells. But because these neighboring cells are not aware of the UE's context, re-establishing connections in the neighboring cells may introduce additional latency and signaling, and thereby negatively impact the end user experience.

Example implementations of the present disclosure therefore provide a solution in which a radio access node 202 may more rapidly shut down (e.g., enter an NES state) to reduce the impact to the end user experience and fully leverage relatively low traffic periods where radio access nodes can enter an NES state. Although example implementations may be described in the context of a radio access node shutting down to enter an NES state (e.g., sleep state), example implementations are equally applicable to shut down of the radio access node for any of a number of other reasons, either expectedly (e.g., configuration update) or unexpectedly.

As explained in greater detail below, the solution of some example implementations may allow a serving radio access node to quickly shut down, and allow the UE(s) served by cell(s) of the serving radio access node to re-establish or resume their connection(s) with cell(s) of a new serving radio access node with a reduced impact on end users with respect UE context availability. This may be achieved by the serving radio access node configured to proactively, speculatively forward the UE context information for the UE(s) to a plurality of radio access nodes within reach of the serving radio access node, referred to in this context as a plurality of reference radio access nodes. In some examples, the solution may be enabled with a graceful shutdown procedure such that the solution is executed after one or more UEs have handed off to neighboring cell(s). Through the solution of some example implementations, the serving radio access node need not wait the entire time window (e.g., 300 seconds) before shutting down its cell(s).

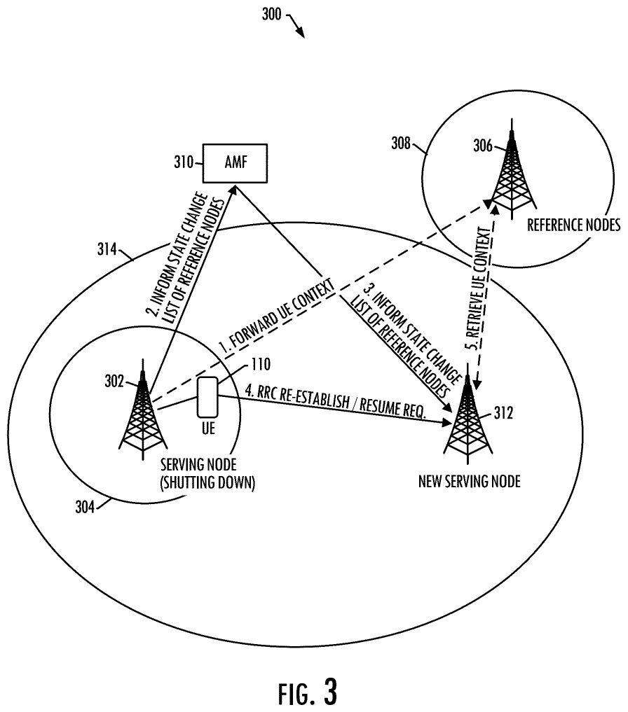

FIG. 3 illustrates a deployment 300 of a PLMN in which a serving radio access node 302 (e.g., gNB) determines to shut down, such as for a NES event, according to some example implementations. The serving radio access node is configured to provide a radio network service to at least one UE 110 from a cell 304 of the serving radio access node. In this regard, the UE(s) may have a connection (e.g., RRC connection) with the serving radio access node. The UE(s) may be in a connected state (e.g., RRC connected) or an inactive state (e.g., RRC inactive) with respect to the serving radio access node. And the serving radio access node may have context information in association with the UE(s) (UE context information).

According to some example implementations, the serving radio access node 302 is configured to determine to shut down the radio network service. The serving radio access node is configured to forward the UE context information for the UE(s) 110 to a plurality of radio access nodes within reach (reference radio access nodes 306). The reference radio access nodes may then store the UE context information for enabling a continued radio network service to the UE(s).

The reference radio access nodes 306 provide respective cells 308 that may not be neighbors of one or more cells 304 of the serving radio access node 302. In some examples, then, the reference radio access nodes may be neighbors of the serving radio access node. The serving radio access node may determine the reference radio access nodes based on one or more factors, such as a probability of selection as a new serving radio access node in view of a mobility pattern of the UE(s) 110, a deployment architecture, an energy efficiency, a system resource availability, or an operations and management (O&M) configuration.

The serving radio access node 302 may forward the UE context information to the reference radio access nodes 306 via a signaling procedure defined as a non-acknowledgement message procedure. In some more particular examples, the serving radio access node may forward the UE context information to the reference radio access nodes over an Xn interface via a class 2 procedure of the Xn application protocol (XnAP). Alternatively, for example, the context information may be forwarded as part of a class 1 procedure where acknowledgement for the context information reception is not required. The non-acknowledgement message procedure may be used given the probability that at least one of the reference radio access nodes will receive the UE context information. This may reduce the need for an acknowledgement, which may in turn lead to a decrease in latency and a savings of resources at the radio interface. In some examples, the serving radio access node 302 is also configured to inform a mobility management function (e.g., AMF 310) of the determined shut down (e.g., NES state change) along with an indication of the reference radio access nodes 306. The mobility management function may then notify at least one candidate node (at least one candidate radio access node) of the reference radio access nodes.

The candidate node(s) may be for providing the continued radio network serviced to the UE(s) 110, and may therefore comprise a new serving radio access node 312. In some examples, the candidate node(s) comprising the new serving radio access node may therefore receive information indicating the reference radio access nodes 306 storing the UE context information for enabling the continued radio network service for the UE(s) 110 when the radio network service is shut down by the serving radio access node 302. Similar to the reference radio access nodes, the candidate node(s) comprising the new serving radio access nodes may receive this information via a signaling procedure defined as a non-acknowledgement message procedure.

In some examples, the candidate node(s) may comprise at least one of the reference radio access nodes. As the candidate node(s) comprise the new serving radio access node 312, the new serving radio access node may be one of the reference radio access nodes. The new serving radio access node may therefore receive the the information indicating the reference radio access nodes from the serving radio access node or the mobility management function. In some examples in which the information is received from the serving radio access node, the information may be received via an XnAP procedure. And in some examples in which the information is received from the serving radio access node, the information may be received via an NGAP procedure. These procedures may be non-acknowledgement message procedures, such as class 2 procedures, or class 1 procedures where acknowledgement for the information reception is not required.

The serving radio access node 302 may also transmit a message to the UE(s) 110 to inform the UE(s) of determined shut down at the serving radio access node, such as the determined shutdown of the cell(s) 304. This may enable at least some of the UE(s) to request the continued radio network service with the new serving radio access node 312 before the UE(s) declare a RLF on the cell(s) of the serving radio access node (e.g., by expiration of the UE's RLF timer).

In some examples, then, the new serving radio access node 312 is configured to receive a request from at least some of the UE(s) 110 to to provide the continued radio network service, such as by a request to re-establish or resume the UE's connection (e.g., RRC connection) with the new serving radio access node. Instead of retrieving the UE context from the serving radio access node 302 that is shut down, the new serving radio access node may retrieve the UE context information from at least one of the reference radio access nodes 306 other than the serving radio access node.

In some more particular examples, the request from the UE 110 comprises an identifier of the serving radio access node 302. The new serving radio access node 312 may retrieve the context information from at least one of the radio access nodes 306 based on the identifier. The continued radio network service may then be provided to the UE from a cell 314 of the new serving radio access node, with the new serving radio access node having the UE context information as retrieved from the at least one of the reference radio access nodes. The UE may therefore now have a connection (e.g., RRC connection) with the new serving radio access node.

FIG. 3 comprises a sequence of signaling between the serving radio access node 302, reference radio access nodes 306, mobility management function (e.g., AMF 310), new serving radio access node 312 and UE 110, in some example implementations. In these examples, the UE has a RRC connection with the serving radio access node, and the UE is in an RRC connected or RRC inactive state. As shown, the serving radio access node may determine to shut down its radio network service to enter an NES state (an NES state change), and proactively transmit the UE context information for UE(s) served by cell(s) of the serving radio access node to the reference radio access nodes, such as over the Xn interface via a non-acknowledgement message procedure. The serving radio access node may also inform the mobility management function of the NES state change, along with the reference radio access nodes storing the UE context information, such as over the NG interface via a NGAP RAN configuration update procedure.

The mobility management function (e.g., AMF 310) may inform candidate node(s) (comprising the new serving radio access node 312) of the NES state change of the serving radio access node 302, and the reference radio access nodes 306 storing UE context information for UE(s) served by cell(s) of the serving radio access node being shut down. These candidate node(s) may comprise radio access nodes in one or more determined areas, such as one or more tracking areas, radio notification areas, or the like. And again, the candidate node(s) may comprise at least one of the reference radio access nodes, and the new serving radio access node may be one of the reference radio access nodes.

The new serving radio access node 312 may receive a request from the UE 110 to re-establish or resume its RRC connection with the new serving radio access node. The request may identify the UE and the cell 304 of the (last) serving radio access node 302. The new serving radio access node may retrieve the UE context information from at least one of the reference radio access nodes 306. In some examples, the new serving radio access node may first determine if one or more conditions are satisfied. These conditions may comprise, for example, that the cell 304 of the (last) serving radio access node 302 (identified in the request) is no longer active, and that the new serving radio access node has information that indicates reference radio access nodes storing the UE context information. In some of these examples, then, the new serving radio access node may retrieve the UE context information from at least one of the reference radio access nodes, when the condition(s) are satisfied.

In some examples, the UE 110 may receive a message from the serving radio access node 302 to inform the UE of the NES state change at the cell 304 of the serving radio access node. In some further examples, the message may also identify one or more candidate nodes for the UE to request continued radio network service. In this regard, the message may identify one or more candidate cells of the candidate node(s), or even one or more candidate beams or frequencies of the candidate node(s) that provide the candidate cell(s). The candidate node(s) may comprise at least one of the reference radio access nodes storing the UE context information. The candidate node(s), cell(s), beam(s) and/or frequency(ies) may be identified in an order of priority for selection by the UE. Additionally or alternatively, the message may identify candidate node(s), cell(s), beam(s) and/or frequency(ies) with which the UE should not request continued radio network service, comprising other cell(s) of the serving radio access node shutting down to enter the NES state.

The serving radio access node 302 may determine the candidate node(s), cell(s), beam(s) and/or frequency(ies) in a number of different manners. In some examples, the candidate node(s), cell(s), beam(s) and/or frequency(ies) may be determined based on UE mobility patterns of the serving radio access node, which may be based each connected UE's current beam, timing advance, reference signal received power (RSRP) or the like. Additionally or alternatively, for example, the candidate node(s), cell(s), beam(s) and/or frequency(ies) may be determined based on reference signal received quality (RSRQ) measurements of the serving cell and neighbor cell(s), location of the UE (if available), or the like. The UE 110 may then select the new serving radio access node 312 based on the candidate node(s), cell(s), beam(s) and/or frequency(ies) provided by the serving radio access node.

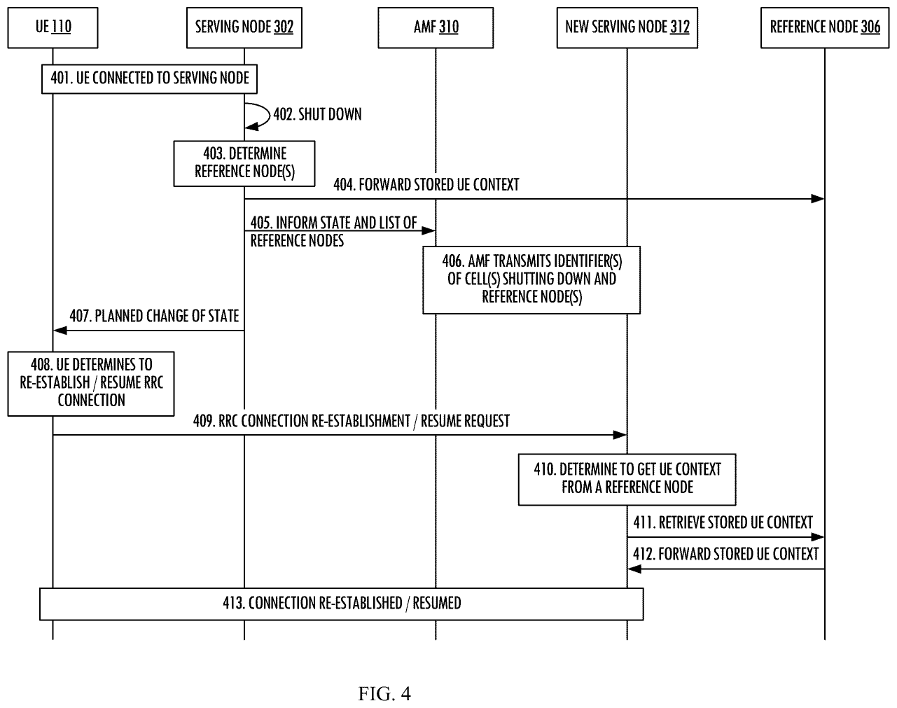

FIG. 4 is a signaling chart for coordination of UE context information between radio access nodes, according to some example implementations. As shown at step 401, the UE 110 is connected to the serving radio access node 302, and thereby provided a radio network service from a cell 304 of the serving radio access node; and the serving radio access node has UE context information for the UE. In some examples, the UE has an RRC connection with the serving radio access node. As shown at step 402, the serving radio access node makes a determination to shut down its radio network service, such as to enter an NES state. And as shown at step 403, the serving radio access node determines reference radio access nodes 306 to forward the UE context information for UE(s) (comprising the UE 110) served by cell(s) of the serving radio access node. These UE(s) may comprise those in an RRC connected state, as well as those in an RRC inactive state.

The serving radio access node 302 may determine the reference radio access nodes 306 based on a number of different factors. In particular, for example, the reference radio access nodes may be determined based on more probable neighbor, candidate radio access node(s) based on UE mobility patterns, such as from handover events, an O&M configuration of the maximum radio access nodes in a reference set, or the like. Additionally or alternatively, the reference radio access nodes may be determined based on the deployment architecture of the candidate nodes. In this regard, a plurality of candidate nodes from past handover events that share DU/CU resources may be determined as reference radio access nodes.

In another example, additionally or alternatively, serving radio access node 302 may determine the reference radio access nodes 306 based on radio access node(s) that are not necessarily neighbors of the serving radio access node, but that have additional available (more than a threshold of available) system resources (e.g., storage resources, compute resources), or that are energy efficient. These radio access nodes may be semi-statically or dynamically determined by O&M or self-organizing network (SON) functions. And as suggested above, in an even further example, the reference radio access nodes may be determined based MNO O&M configuration.

As shown at step 404, the serving radio access node 302 being shut down forwards the UE context information for the UE(s) 110 served by cell(s) of the serving radio access node to the reference radio access nodes 306, such as over an Xn interface via a non-acknowledgement message procedure. The serving radio access node also informs the AMF 310 of the determined shut down (e.g., NES state change), and identifies the reference radio access nodes storing the UE context information, such as over an NG interface via an NGAP procedure, as shown at step 405. In some examples comprising multiple reference radio access nodes, the serving radio access node may identify the reference radio access nodes in an order of priority.

As shown at step 406, the AMF 310 transmits information to candidate node(s) (comprising new serving radio access node 312) that identifies the cell(s) of the serving radio access node 302 being shut down, and indicates the reference radio access nodes 306. The information may be transmitted over an NG interface, such as via a non-acknowledgement message procedure. The candidate nodes may comprise those in a geographical area that may be determined based on, for example, configured handover relationships of the cell(s) shutting down, tracking or registration area configurations, or the like.

The serving radio access node 302 may transmit a message to inform the UE(s) 110 of the determined shut down of cell(s) serving the UE(s), as shown at step 407. As described above, the message may identify the cell(s) of the serving radio access node being shut down, comprising for a UE, the cell 304 serving the UE and any other cells of the serving radio access node being shut down. The message may also identify candidate node(s), cell(s), beam(s) and/or frequency(ies) for the UE to request continued radio network service, or for which the UE should not request continued radio network service.

The serving radio access node 302 may transmit the message to the UE(s) 110 at step 407 in a number of different manners. In some examples, the serving radio access node may transmit the message as a group common physical downlink control channel (GC-PDCCH) message. Additionally or alternatively, in some examples, the serving radio access node may transmit the message as an RRC message. In another example, additionally or alternatively, the serving radio access node may transmit the message as system information in one or more system information blocks (SIBs).

As shown at step 408, the UE 110 determines to request continued radio network service, such as by re-establishing or resuming its RRC connection in a cell of a new serving radio access node 312. In some examples in which the message from the serving radio access node 302 identifies candidate node(s), the UE may select the new serving radio access node from the candidate node(s). Similarly, the UE may select a cell 314 of the new serving radio access node from a plurality of cells that exclude cell(s) of the serving radio access node being shut down.

As shown at step 409, the UE 110 may then transmit a request for continued radio network service to the new serving radio access node 312. In some more particular examples of steps 408 and 409, the UE may perform a cell (re) selection to a potential active cell; and upon selecting a suitable cell, the UE may initiate an RRC re-establishment or RRC resume procedure with a cell 314 (new serving cell) of the new serving radio access node, and inform the cell of its previously existing UE context and serving cell identifier. And because the UE has received the message from the serving radio access node 302 to inform the UE of the determined shut down of the serving radio access node, the UE may request the continued radio network service with the cell 314 of the new serving radio access node before declaring a RLC on the cell 304 of the serving radio access node shut down.

As shown at step 410, the new serving radio access node 312 receives the request from the UE 110, and determines to retrieve the UE context information from at least one of the reference radio access nodes 306, based on the information from the AMF 310 and the request that both comprise an identifier of the serving radio access node 302 (e.g., identifier of the cell 304 of the serving radio access node). In some examples, then, the new serving radio access node, receiving a request form the UE to re-establish or resume the RRC connection for a serving radio access node 302 for which the AMF 310 provided reference radio access nodes, determines to retrieve the UE context information from the reference radio access nodes, instead of from the (last) serving radio access node or cell.

As shown at steps 411 and 412, the new serving radio access node 312 transmits a request for the UE context information to at least one of the reference radio access nodes 306, and receives the UE context information from the at least one of the reference radio access nodes based on the request. In some examples in which the UE context information at the reference radio access nodes is for a plurality of UEs that comprise the UE 110, the request may identify the UE. Likewise, the request may identify the cell 304 of the (last) serving radio access node 302. The UE context information received by the new serving radio access node, then, may be for the UE as identified.

Additionally or alternatively, in some examples, the UE context information may be for the plurality of UEs that are provided the radio network service from one or more cells of a plurality of serving radio access nodes comprising the (last) serving radio access node 302. In some of these examples, the request from the new serving radio access node 312 may identify the UE 110 and the cell 304 of the serving radio access node. The UE context information transmitted to the new serving radio access node, then, may be the UE context information for the UE as identified, used to maintain the radio network service from the cell of the serving radio access node.

In examples in which the new serving radio access node 312 is provided with multiple reference radio access nodes 306, the new serving radio access node may attempt to retrieve the UE context information from more than one reference radio access node. In another example, the new serving radio access node may attempt to retrieve the UE context information based on an order of priority in which the AMF 310 provided the reference radio access nodes to the new serving radio access node. In some of these examples, the new serving radio access node may first attempt to retrieve the UE context information from a first of the reference radio access nodes in the order of priority, and if the first attempt fails, then attempt to retrieve the UE context information from a second of the reference radio access nodes in the order of priority, and so forth. In yet other examples, the new serving radio access node may attempt to retrieve the UE context information from a randomly-selected one of the reference radio access nodes, or from any of the reference radio access nodes with which the new serving radio access node has an Xn network interface.

As shown at step 413, the new serving radio access node 312 provides the continued radio network service to the UE 110 from the cell 314 of the new serving radio access node 312 having the UE context information. In some examples, then, the RRC connection of the UE is re-established or resumed with the cell of the new serving radio access node.

In some examples, the reference radio access nodes 306 may be configured to delete the UE context information when one or more conditions are satisfied. These condition(s) may comprise, for example, passage of a period of time in which the UE context information is not requested by a new serving radio access node 312, where the period of time may be established, for example, based on RLF timers. Additionally or alternatively, the condition(s) for deletion the UE context information may comprise that the cell(s) of the (formerly) serving radio access node 302 are no longer shut down, which the mobility managem (e.g., AMF 310) may inform the reference radio access nodes.

In some examples, the reference radio access nodes 306 may be configured to provide messaging feedback to the serving radio access node 302 with information that indicates for which UE(s) 110 the UE context information was or was not retrieved by a new serving radio access node 312. The serving radio access node may use this information to make subsequent determinations as to what UE context information is provided to what reference radio access nodes. Additionally or alternatively, the information may be used by the serving radio access node to utilize other UE attributes to select what UE context information to forward when the serving radio access node next determines to shut down. The information in some of these examples may be used with advanced predictive or prescriptive analytics techniques such as those based on artificial intelligence (AI)/machine learning (ML).

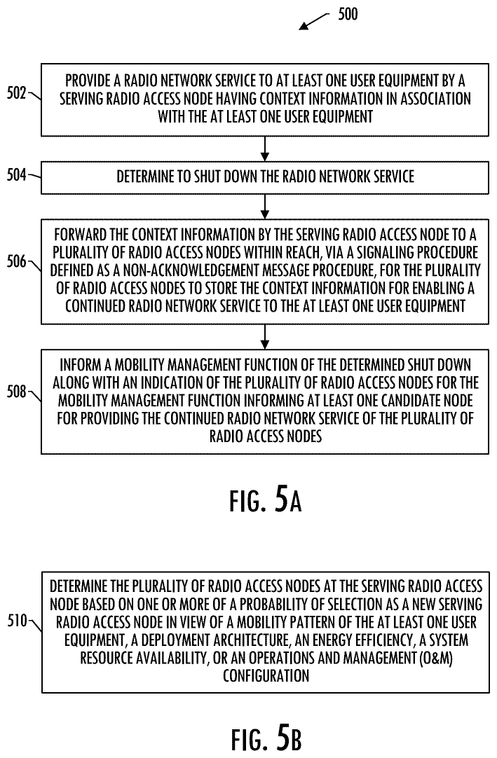

FIGS. 5A, 5B and 5C are flowcharts illustrating various steps in a method 500 that may be implemented at a serving radio access node, according to various example implementations. The method comprises providing a radio network service to at least one user equipment by the serving radio access node having context information in association with the at least one user equipment, as shown at block 502 of FIG. 5A. The method comprises determining to shut down the radio network service, as shown at block 504. The method comprises forwarding the context information by the serving radio access node to a plurality of radio access nodes within reach, via a signaling procedure defined as a non-acknowledgement message procedure, for the plurality of radio access nodes to store the context information for enabling a continued radio network service to the at least one user equipment, as shown at block 506. And the method comprises informing a mobility management function of the determined shut down along with an indication of the plurality of radio access nodes for the mobility management function informing at least one candidate node for providing the continued radio network service of the plurality of radio access nodes, as shown at block 508.

In some examples, the method 500 further comprises determining the plurality of radio access nodes at the serving radio access node, as shown at block 510 of FIG. 5B. In some of these examples, the plurality of radio access nodes are determined based on one or more of a probability of selection as a new serving radio access node in view of a mobility pattern of the at least one user equipment, a deployment architecture, an energy efficiency, a system resource availability, or an operations and management (O&M) configuration.

In some examples, the radio network service is provided to the at least one user equipment at block 502 by at least one cell of the serving radio access node. In some of these examples, the method further comprises transmitting a message by the serving radio access node to inform the at least one user equipment of the determined shut down, as shown at block 512 of FIG. 5C. In some of these examples, at least some of the at least one user equipment may thereby be enabled to request the continued radio network service before a radio link failure on the at least one cell of the serving radio access node is declared.

In some examples, the message that is transmitted at block 512 also identifies at least some of the at least one candidate node for selection as a new serving radio access node for providing the continued radio network service.

In some examples, the least some of the at least one candidate node are a plurality of candidate nodes identified by the message in an order of priority for selection as the new serving radio access node.

In some examples, the at least one candidate node comprises at least one of the plurality of radio access nodes.

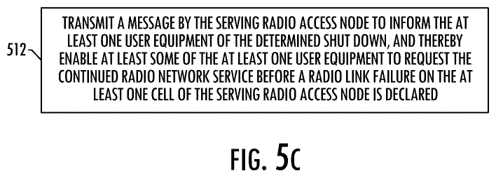

FIGS. 6A and 6B are flowcharts illustrating various steps in a method 600 that may be implemented at a new serving radio access node, according to various example implementations. The method comprises receiving information, via a signaling procedure defined as a non-acknowledgement message procedure, indicating a plurality of radio access nodes storing context information in association with at least one user equipment for enabling a continued radio network service for the at least one user equipment when a radio network service shut down is carried out by a serving radio access node, as shown at block 602 of FIG. 6A. The method comprises receiving a request from at least some of the at least one user equipment to provide the continued radio network service, In some of these examples, the request comprises an identifier of the serving radio access node, as shown at block 604. The method comprises retrieving, based on the identifier, the context information from at least one of the plurality of radio access nodes, as shown at block 606. And the method comprises providing the continued radio network service to the at least some of the at least one user equipment, as shown at block 608.

In some examples, the information is received at block 602 from the serving radio access node, or a mobility management function informed of the plurality of radio access nodes by the serving radio access nodes.

In some examples, the radio network service shut down is a determined shut down, and the information that is received at block 602 comprises an indication of the determined shut down.

In some examples, retrieving the context information at block 606 comprises determining to retrieve the context information from the at least one of the plurality of radio access nodes, based on the request and the information that also comprises the identifier of the serving radio access node, as shown at block 610 of FIG. 6B. In some of these examples, retrieving the context information comprises transmitting a request for the context information to the at least one of the plurality of radio access nodes, as shown at block 612. And the method comprises receiving the context information from the at least one of the plurality of radio access nodes, in association with the request for the context information, as shown at block 614.

According to example implementations of the present disclosure, a telecommunications system 100 or PLMN 102, and its components such as the CN 106, RAN 108, UE 110, radio access node 202, serving radio access node 302, reference radio access node 306, AMF 310 and/or new serving radio access node 312, may be implemented by various means. Means for implementing the system and its components may comprise hardware, firmware, software, or combinations thereof. In some examples, one or more apparatuses may be configured to function as or otherwise implement the system and its components shown and described herein. In examples involving more than one apparatus, the respective apparatuses may be connected to or otherwise in communication with one another in a number of different manners, such as directly or indirectly via a wired or wireless network or the like.

According to some example implementations, at least some of the method 500 described with respect to FIGS. 5A-5C may be carried out by an apparatus comprising means for performing functions corresponding steps of the method. Similarly, at least some of the method 600 described with respect to FIGS. 6A and 6B may be carried out by an apparatus comprising means for performing functions corresponding steps of the method. A suitable apparatus may comprise, for example, a gNB (e.g., gNB-DU, gNB-CU), ng-eNB or any suitable apparatus, such as a server, host or node.

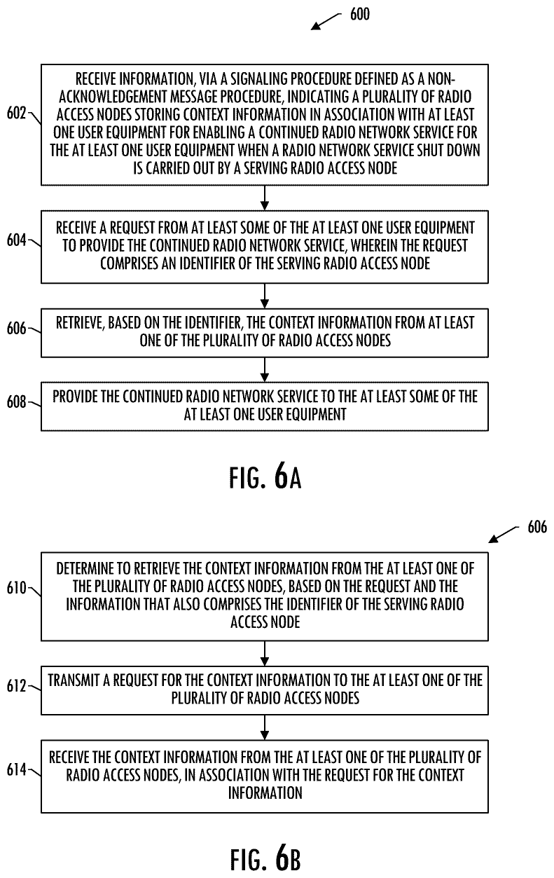

FIG. 7 illustrates an apparatus 700 comprising means for performing functions corresponding to steps of the method 500 shown in FIG. 5A. As shown, the apparatus comprises means 702 for providing a radio network service to at least one user equipment by a serving radio access node having context information in association with the at least one user equipment. The apparatus comprises means 704 for determining to shut down the radio network service. The apparatus comprises means 706 for forwarding the context information by the serving radio access node to a plurality of radio access nodes within reach, via a signaling procedure defined as a non-acknowledgement message procedure, for the plurality of radio access nodes to store the context information for enabling a continued radio network service to the at least one user equipment. And the apparatus comprises means 708 for informing a mobility management function of the determined shut down along with an indication of the plurality of radio access nodes for the mobility management function informing at least one candidate node for providing the continued radio network service of the plurality of radio access nodes. Although not separately shown, the apparatus may comprise similar means for performing functions corresponding to the steps shown either or both in FIG. 5B or FIG. 5C.

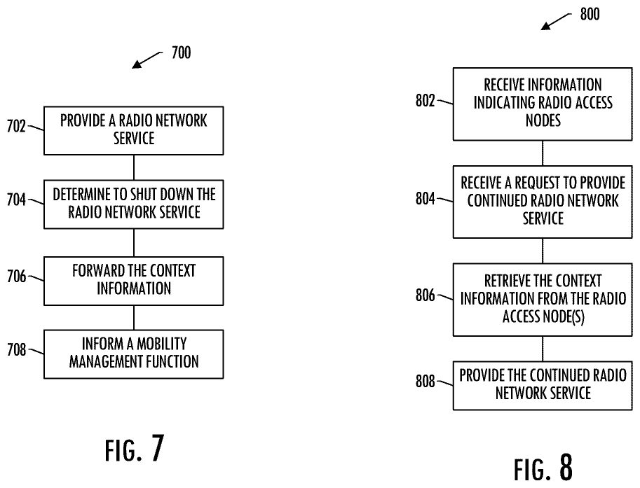

FIG. 8 illustrates an apparatus 800 comprising means for performing functions corresponding to steps of the method 600 shown in FIG. 6A. As shown, the apparatus comprises means 802 for receiving information, via a signaling procedure defined as a non-acknowledgement message procedure, indicating a plurality of radio access nodes storing context information in association with at least one user equipment for enabling a continued radio network service for the at least one user equipment when a radio network service shut down is carried out by a serving radio access node. The apparatus comprises means 804 for receiving a request from at least some of the at least one user equipment to provide the continued radio network service, wherein the request comprises an identifier of the serving radio access node. The apparatus comprises means 806 for retrieving, based on the identifier, the context information from at least one of the plurality of radio access nodes. And the apparatus comprises means 808 for providing the continued radio network service to the at least some of the at least one user equipment. Although not separately shown, the apparatus may comprise similar means for performing functions corresponding to the steps shown in FIG. 6B.

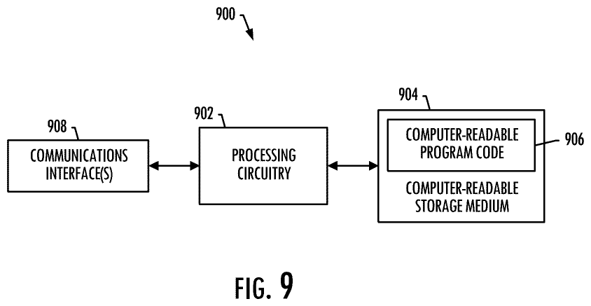

FIG. 9 illustrates an apparatus 900 in which means for performing various functions comprises hardware, alone or under direction of one or more computer programs from a computer-readable storage medium, such as computer memory (or more simply “memory”), according to some example implementations of the present disclosure. The apparatus may comprise one or more of each of a number of components such as, for example, processing circuitry 902 connected to computer-readable storage medium 904.

The processing circuitry 902 may be composed of one or more processors alone or in combination with one or more computer-readable storage media. The processing circuitry is generally any piece of computer hardware that is capable of processing information such as, for example, data, computer programs and/or other suitable electronic information. The processing circuitry is composed of a collection of electronic circuits some of which may be packaged as an integrated circuit or multiple interconnected integrated circuits (an integrated circuit at times more commonly referred to as a “chip”). The processing circuitry may be configured to execute computer programs, which may be stored onboard the processing circuitry or otherwise stored in the computer-readable storage medium 904 (of the same or another apparatus).

The processing circuitry 902 may be a number of processors, a multi-core processor or some other type of processor, depending on the particular implementation. Further, the processing circuitry may be implemented using a number of heterogeneous processor systems in which a main processor is present with one or more secondary processors on a single chip. As another illustrative example, the processing circuitry may be a symmetric multi-processor system containing multiple processors of the same type. In yet another example, the processing circuitry may be embodied as or otherwise comprise one or more ASICs, FPGAs or the like. Thus, although the processing circuitry may be capable of executing a computer program to perform one or more functions, the processing circuitry of various examples may be capable of performing one or more functions without the aid of a computer program. In either instance, the processing circuitry may be appropriately programmed to perform functions or operations according to example implementations of the present disclosure.

The computer-readable storage medium 904 is generally any piece of computer hardware that is capable of storing information such as, for example, data, computer programs (e.g., computer-readable program code 906) and/or other suitable information either on a temporary basis and/or a permanent basis. The computer-readable storage medium may comprise volatile and/or non-volatile memory, and may be fixed or removable. Examples of suitable memory comprise recording media, random access memory (RAM), read-only memory (ROM), a hard drive, a flash memory, a thumb drive, a removable computer diskette, an optical disk, or some combination thereof.

The computer-readable storage medium 904 is a non-transitory device capable of storing information, and is distinguishable from a computer-readable transmission medium capable of carrying information from one location to another. Examples of suitable computer-readable transmission media comprise electronic carrier signals, telecommunications signals, software distribution packages, or some combination thereof. As used herein, the term “non-transitory” is a limitation of the medium itself (i.e., tangible, not a signal) as opposed to a limitation on data storage persistency (e.g., RAM versus ROM). A computer-readable medium as described herein generally refers to a computer-readable storage medium or computer-readable transmission medium. A computer-readable medium is any entity or device capable in which information, such as one or more computer programs or portions thereof, may be stored and carried.

In addition to the computer-readable storage medium 904, the processing circuitry 902 may also be connected to one or more interfaces for displaying, transmitting and/or receiving information. The interfaces may comprise a communications interface 908 and/or one or more user interfaces (e.g., display, user input interface). The communications interface may be configured to transmit and/or receive information, such as to and/or from other apparatus(es), network(s) or the like. The communications interface may be configured to transmit and/or receive information by physical (wired) and/or wireless communications links. Examples of suitable communications interfaces comprise a network interface controller (NIC), wireless NIC (WNIC) or the like.

In some examples, the communications interface comprises a radio interface, which itself comprises hardware and/or software for realizing communication connectivity according to one or more communication protocols. For example, the radio interface may enable the apparatus 900 to communicate over a radio access network. The radio interface may comprise standard well-known components such as an amplifier, filter, frequency-converter, (de) modulator, encoder/decoder circuitries, and one or more antennas. The radio interface may provide access to one or more network interfaces, and/or provide uplink and/or downlink communication capabilities.

Execution of the computer-readable program code 906 by the processing circuitry 902, or storage of the computer-readable program code in the computer-readable storage medium 904, supports combinations of operations for implementing example implementations of the present disclosure. In this manner, an apparatus 900 may comprise at least one processing circuitry and at least one computer-readable storage medium coupled to the at least one processing circuitry, where the at least one processing circuitry is configured to execute computer-readable program code stored in the at least one computer-readable storage medium. It will also be understood that one or more functions, and combinations of functions, may be implemented by special purpose hardware-based computer systems and/or processing circuitry which perform the specified functions, or combinations of special purpose hardware and program code instructions.

Some example implementations of the present disclosure may also be carried out in the form of a computer process defined by one or more computer programs or portions thereof. Example implementations of the present disclosure may be carried out by executing at least one portion of a computer program comprising computer-readable program code. The computer program may be in source code form, object code form, or in some intermediate form. The computer program may be stored in a computer-readable medium that is readable by a computer, processing circuitry or other suitable apparatus. As indicated above, for example, the computer program may be stored in a computer-readable storage medium. Additionally or alternatively, for example, the computer program may be stored in a computer-readable transmission medium. The coding of software for carrying out example implementations of the present disclosure is well within the scope of a person of ordinary skill in the art.

As will be appreciated, any suitable computer-readable program code may be loaded onto a computer, a processing circuitry or other programmable apparatus from a computer-readable medium (e.g., computer-readable storage medium, computer-readable transmission medium) to produce a particular machine, such that the particular machine becomes a means for implementing the functions specified herein. The computer-readable program code may also be stored in a computer-readable medium that can direct a computer, a processing circuitry or other programmable apparatus to function in a particular manner to thereby generate a particular machine or particular article of manufacture. In some examples, the computer-readable program code stored in the computer-readable medium may produce an article of manufacture, where the article of manufacture becomes a means for implementing functions described herein. The computer-readable program code may be retrieved from a computer-readable medium and loaded into a computer, processing circuitry or other programmable apparatus to configure the computer, processing circuitry or other programmable apparatus to execute operations to be performed on or by the computer, processing circuitry or other programmable apparatus.

Retrieval, loading and execution of computer-readable program code comprising program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processing circuitry or other programmable apparatus provide operations for implementing functions described herein.

As explained above and reiterated below, the present disclosure comprises, without limitation, the following example implementations.

Clause 1. An apparatus comprising: at least one memory configured to store computer-readable program code; and at least one processing circuitry configured to access the at least one memory, and execute the computer-readable program code to cause the apparatus to at least: provide a radio network service to at least one user equipment by a serving radio access node having context information in association with the at least one user equipment; determine to shut down the radio network service; forward the context information by the serving radio access node to a plurality of radio access nodes within reach, via a signaling procedure defined as a non-acknowledgement message procedure, for the plurality of radio access nodes to store the context information for enabling a continued radio network service to the at least one user equipment; and inform a mobility management function of the determined shut down along with an indication of the plurality of radio access nodes for the mobility management function informing at least one candidate node for providing the continued radio network service of the plurality of radio access nodes.

Clause 2. The apparatus of clause 1, wherein the at least one processing circuitry is configured to execute the computer-readable program code to cause the apparatus to further determine the plurality of radio access nodes at the serving radio access node based on one or more of a probability of selection as a new serving radio access node in view of a mobility pattern of the at least one user equipment, a deployment architecture, an energy efficiency, a system resource availability, or an operations and management (O&M) configuration.

Clause 3. The apparatus of clause 1 or clause 2, wherein the radio network service is provided to the at least one user equipment by at least one cell of the serving radio access node, and wherein the at least one processing circuitry is configured to execute the computer-readable program code to cause the apparatus to further transmit a message by the serving radio access node to inform the at least one user equipment of the determined shut down, and thereby enable at least some of the at least one user equipment to request the continued radio network service before a radio link failure on the at least one cell of the serving radio access node is declared.

Clause 4. The apparatus of clause 3, wherein the message that is transmitted also identifies at least some of the at least one candidate node for selection as a new serving radio access node for providing the continued radio network service.

Clause 5. The apparatus of clause 4, wherein the least some of the at least one candidate node are a plurality of candidate nodes identified by the message in an order of priority for selection as the new serving radio access node.

Clause 6. The apparatus of any of clauses 1 to 5, wherein the at least one candidate node comprises at least one of the plurality of radio access nodes.

Clause 7. A method comprising: providing a radio network service to at least one user equipment by a serving radio access node having context information in association with the at least one user equipment; determining to shut down the radio network service; forwarding the context information by the serving radio access node to a plurality of radio access nodes within reach, via a signaling procedure defined as a non-acknowledgement message procedure, for the plurality of radio access nodes to store the context information for enabling a continued radio network service to the at least one user equipment; and informing a mobility management function of the determined shut down along with an indication of the plurality of radio access nodes for the mobility management function informing at least one candidate node for providing the continued radio network service of the plurality of radio access nodes.

Clause 8. The method of clause 7, wherein the method further comprises determining the plurality of radio access nodes at the serving radio access node based on one or more of a probability of selection as a new serving radio access node in view of a mobility pattern of the at least one user equipment, a deployment architecture, an energy efficiency, a system resource availability, or an operations and management (O&M) configuration.

Clause 9. The method of clause 7 or clause 8, wherein the radio network service is provided to the at least one user equipment by at least one cell of the serving radio access node, and wherein the method further comprises transmitting a message by the serving radio access node to inform the at least one user equipment of the determined shut down, and thereby enable at least some of the at least one user equipment to request the continued radio network service before a radio link failure on the at least one cell of the serving radio access node is declared.

Clause 10. The method of clause 9, wherein the message that is transmitted also identifies at least some of the at least one candidate node for selection as a new serving radio access node for providing the continued radio network service.

Clause 11. The method of clause 10, wherein the least some of the at least one candidate node are a plurality of candidate nodes identified by the message in an order of priority for selection as the new serving radio access node.

Clause 12. The method of any of clauses 7 to 11, wherein the at least one candidate node comprises at least one of the plurality of radio access nodes.

Clause 13. A computer-readable storage medium that is non-transitory and has computer-readable program code stored therein that, in response to execution by at least one processing circuitry, causes an apparatus to at least: provide a radio network service to at least one user equipment by a serving radio access node having context information in association with the at least one user equipment; determine to shut down the radio network service; forward the context information by the serving radio access node to a plurality of radio access nodes within reach, via a signaling procedure defined as a non-acknowledgement message procedure, for the plurality of radio access nodes to store the context information for enabling a continued radio network service to the at least one user equipment; and inform a mobility management function of the determined shut down along with an indication of the plurality of radio access nodes for the mobility management function informing at least one candidate node for providing the continued radio network service of the plurality of radio access nodes.

Clause 14. The computer-readable storage medium of clause 13, wherein the computer-readable storage medium has further computer-readable program code stored therein that, in response to execution by the at least one processing circuitry, causes the apparatus to further determine the plurality of radio access nodes at the serving radio access node based on one or more of a probability of selection as a new serving radio access node in view of a mobility pattern of the at least one user equipment, a deployment architecture, an energy efficiency, a system resource availability, or an operations and management (O&M) configuration.

Clause 15. The computer-readable storage medium of clause 13 or clause 14, wherein the radio network service is provided to the at least one user equipment by at least one cell of the serving radio access node, and wherein the computer-readable storage medium has further computer-readable program code stored therein that, in response to execution by the at least one processing circuitry, causes the apparatus to further transmit a message by the serving radio access node to inform the at least one user equipment of the determined shut down, and thereby enable at least some of the at least one user equipment to request the continued radio network service before a radio link failure on the at least one cell of the serving radio access node is declared.

Clause 16. The computer-readable storage medium of clause 15, wherein the message that is transmitted also identifies at least some of the at least one candidate node for selection as a new serving radio access node for providing the continued radio network service.

Clause 17. The computer-readable storage medium of clause 16, wherein the least some of the at least one candidate node are a plurality of candidate nodes identified by the message in an order of priority for selection as the new serving radio access node.

Clause 18. The computer-readable storage medium of any of clauses 13 to 17, wherein the at least one candidate node comprises at least one of the plurality of radio access nodes.

Clause 19. An apparatus comprising means for performing the method of any of clauses 7 to 12.

Clause 20. A computer-readable medium comprising computer-readable program code that, in response to execution by at least one at least one processing circuitry, causes an apparatus to perform the method of any of clauses 7 to 12.

Clause 21. A computer-readable storage medium comprising computer-readable program code that, in response to execution by at least one at least one processing circuitry, causes an apparatus to perform the method of any of clauses 7 to 12.

Clause 22. A computer program comprising computer-readable program code that, in response to execution by at least one at least one processing circuitry, causes an apparatus to perform the method of any of clauses 7 to 12.

Clause 23. An apparatus comprising: at least one memory configured to store computer-readable program code; and at least one processing circuitry configured to access the at least one memory, and execute the computer-readable program code to cause the apparatus to at least: receive information, via a signaling procedure defined as a non-acknowledgement message procedure, indicating a plurality of radio access nodes storing context information in association with at least one user equipment for enabling a continued radio network service for the at least one user equipment when a radio network service shut down is carried out by a serving radio access node; receive a request from at least some of the at least one user equipment to provide the continued radio network service, wherein the request comprises an identifier of the serving radio access node; retrieve, based on the identifier, the context information from at least one of the plurality of radio access nodes; and provide the continued radio network service to the at least some of the at least one user equipment.

Clause 24. The apparatus of clause 23, wherein the information is received from the serving radio access node, or a mobility management function informed of the plurality of radio access nodes by the serving radio access nodes.

Clause 25. The apparatus of clause 24, wherein the radio network service shut down is a determined shut down, and the information that is received comprises an indication of the determined shut down.

Clause 26. The apparatus of any of clauses 23 to 25, wherein the apparatus caused to retrieve the context information comprises the apparatus caused to: determine to retrieve the context information from the at least one of the plurality of radio access nodes, based on the request and the information that also comprises the identifier of the serving radio access node; transmit a request for the context information to the at least one of the plurality of radio access nodes; and receive the context information from the at least one of the plurality of radio access nodes, in association with the request for the context information.

Clause 27. A method comprising: receiving information, via a signaling procedure defined as a non-acknowledgement message procedure, indicating a plurality of radio access nodes storing context information in association with at least one user equipment for enabling a continued radio network service for the at least one user equipment when a radio network service shut down is carried out by a serving radio access node; receiving a request from at least some of the at least one user equipment to provide the continued radio network service, wherein the request comprises an identifier of the serving radio access node; retrieving, based on the identifier, the context information from at least one of the plurality of radio access nodes; and providing the continued radio network service to the at least some of the at least one user equipment.

Clause 28. The method of clause 27, wherein the information is received from the serving radio access node, or a mobility management function informed of the plurality of radio access nodes by the serving radio access nodes.

Clause 29. The method of clause 28, wherein the radio network service shut down is a determined shut down, and the information that is received comprises an indication of the determined shut down.

Clause 30. The method of any of clauses 27 to 29, wherein retrieving the context information comprises: determining to retrieve the context information from the at least one of the plurality of radio access nodes, based on the request and the information that also comprises the identifier of the serving radio access node; transmitting a request for the context information to the at least one of the plurality of radio access nodes; and receiving the context information from the at least one of the plurality of radio access nodes, in association with the request for the context information.

Clause 31. A computer-readable storage medium that is non-transitory and has computer-readable program code stored therein that, in response to execution by at least one processing circuitry, causes an apparatus to at least: receive information, via a signaling procedure defined as a non-acknowledgement message procedure, indicating a plurality of radio access nodes storing context information in association with at least one user equipment for enabling a continued radio network service for the at least one user equipment when a radio network service shut down is carried out by a serving radio access node; receive a request from at least some of the at least one user equipment to provide the continued radio network service, wherein the request comprises an identifier of the serving radio access node; retrieve, based on the identifier, the context information from at least one of the plurality of radio access nodes; and provide the continued radio network service to the at least some of the at least one user equipment.

Clause 32. The computer-readable storage medium of clause 31, wherein the information is received from the serving radio access node, or a mobility management function informed of the plurality of radio access nodes by the serving radio access nodes.

Clause 33. The computer-readable storage medium of clause 32, wherein the radio network service shut down is a determined shut down, and the information that is received comprises an indication of the determined shut down.

Clause 34. The computer-readable storage medium of any of clauses 31 to 33, wherein the apparatus caused to retrieve the context information comprises the apparatus caused to: determine to retrieve the context information from the at least one of the plurality of radio access nodes, based on the request and the information that also comprises the identifier of the serving radio access node; transmit a request for the context information to the at least one of the plurality of radio access nodes; and receive the context information from the at least one of the plurality of radio access nodes, in association with the request for the context information.

Clause 35. An apparatus comprising means for performing the method of any of clauses 27 to 30.

Clause 36. A computer-readable medium comprising computer-readable program code that, in response to execution by at least one at least one processing circuitry, causes an apparatus to perform the method of any of clauses 27 to 30.

Clause 37. A computer-readable storage medium comprising computer-readable program code that, in response to execution by at least one at least one processing circuitry, causes an apparatus to perform the method of any of clauses 27 to 30.

Clause 38. A computer program comprising computer-readable program code that, in response to execution by at least one at least one processing circuitry, causes an apparatus to perform the method of any of clauses 27 to 30.

Many modifications and other implementations of the disclosure set forth herein will come to mind to one skilled in the art to which the disclosure pertains having the benefit of the teachings presented in the foregoing description and the associated figures. Therefore, it is to be understood that the disclosure is not to be limited to the specific implementations disclosed and that modifications and other implementations are intended to be included within the scope of the appended claims. Moreover, although the foregoing description and the associated figures describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus comprising: at least one memory configured to store computer-readable program code; and at least one processing circuitry configured to access the at least one memory, and execute the computer-readable program code to cause the apparatus to at least:
provide a radio network service to at least one user equipment by a serving radio access node having context information in association with the at least one user equipment;
determine to shut down the radio network service;
forward the context information by the serving radio access node to a plurality of radio access nodes within reach, via a signaling procedure defined as a non-acknowledgement message procedure, for the plurality of radio access nodes to store the context information for enabling a continued radio network service to the at least one user equipment; and
inform a mobility management function of the determined shut down along with an indication of the plurality of radio access nodes for the mobility management function informing at least one candidate node for providing the continued radio network service of the plurality of radio access nodes.

2. The apparatus of claim 1, wherein the apparatus is further configured to determine the plurality of radio access nodes based on one or more of a probability of selection as a new serving radio access node in view of a mobility pattern of the at least one user equipment, a deployment architecture, an energy efficiency, a system resource availability, or an operations and management (O&M) configuration.

3. The apparatus of claim 1, wherein the radio network service is provided to the at least one user equipment by at least one cell of the serving radio access node, and
wherein the apparatus is further configured to transmit a message by the serving radio access node to inform the at least one user equipment of the determination, and thereby enable at least some of the at least one user equipment to request the continued radio network service before a radio link failure on the at least one cell of the serving radio access node is declared.

4. The apparatus of claim 1, wherein the radio network service is provided to the at least one user equipment by at least one cell of the serving radio access node, wherein the apparatus is further configured to transmit a message by the serving radio access node to inform the at least one user equipment of the determination, and thereby enable at least some of the at least one user equipment to request the continued radio network service before a radio link failure on the at least one cell of the serving radio access node is declared, and wherein the message that is transmitted also identifies at least some of the at least one candidate node for selection as a new serving radio access node for providing the continued radio network service.

5. The apparatus of claim 1, wherein the at least one candidate node comprises at least one of the plurality of radio access nodes.

6. A method comprising:
providing a radio network service to at least one user equipment by a serving radio access node having context information in association with the at least one user equipment;
determining to shut down the radio network service;
forwarding the context information by the serving radio access node to a plurality of radio access nodes within reach, via a signaling procedure defined as a non-acknowledgement message procedure, for the plurality of radio access nodes to store the context information for enabling a continued radio network service to the at least one user equipment; and
informing a mobility management function of the determined shut down along with an indication of the plurality of radio access nodes for the mobility management function informing at least one candidate node for providing the continued radio network service of the plurality of radio access nodes.

7. The method of claim 6, wherein the method further comprises determining the plurality of radio access nodes at the serving radio access node based on one or more of a probability of selection as a new serving radio access node in view of a mobility pattern of the at least one user equipment, a deployment architecture, an energy efficiency, a system resource availability, or an operations and management (O&M) configuration.

8. The method of claim 6, wherein the radio network service is provided to the at least one user equipment by at least one cell of the serving radio access node, and
wherein the method further comprises transmitting a message by the serving radio access node to inform the at least one user equipment of the determined shut down, and thereby enable at least some of the at least one user equipment to request the continued radio network service before a radio link failure on the at least one cell of the serving radio access node is declared.

9. The method of claim 6, wherein the radio network service is provided to the at least one user equipment by at least one cell of the serving radio access node, wherein the method further comprises transmitting a message by the serving radio access node to inform the at least one user equipment of the determined shut down, and thereby enable at least some of the at least one user equipment to request the continued radio network service before a radio link failure on the at least one cell of the serving radio access node is declared, and wherein the message that is transmitted also identifies at least some of the at least one candidate node for selection as a new serving radio access node for providing the continued radio network service.

10. The method of claim 6, wherein the at least one candidate node comprises at least one of the plurality of radio access nodes.

11. An apparatus comprising: at least one memory configured to store computer-readable program code; and at least one processing circuitry configured to access the at least one memory, and execute the computer-readable program code to cause the apparatus to at least:
receive information, via a signaling procedure defined as a non-acknowledgement message procedure, indicating a plurality of radio access nodes storing context information in association with at least one user equipment for enabling a continued radio network service for the at least one user equipment when a radio network service shut down is carried out by a serving radio access node;
receive a request from at least some of the at least one user equipment to provide the continued radio network service, wherein the request comprises an identifier of the serving radio access node;
retrieve, based on the identifier, the context information from at least one of the plurality of radio access nodes, and
provide the continued radio network service to the at least some of the at least one user equipment.

12. The apparatus of claim 11, wherein the information is received from the serving radio access node, or a mobility management function informed of the plurality of radio access nodes by the serving radio access node.

13. The apparatus of claim 11, wherein the information is received from the serving radio access node, or a mobility management function informed of the plurality of radio access nodes by the serving radio access node, and wherein the radio network service shut down is a determined shut down, and the information that is received comprises an indication of the determined shut down.

14. The apparatus of claim 11, wherein the retrieving the context information comprises:
determining to retrieve the context information from the at least one of the plurality of radio access nodes, based on the request and the information that also comprises the identifier of the serving radio access node;
transmitting a request for the context information to the at least one of the plurality of radio access nodes; and
receiving the context information from the at least one of the plurality of radio access nodes, in association with the request for the context information.

15. A method comprising:
receiving information, via a signaling procedure defined as a non-acknowledgement message procedure, indicating a plurality of radio access nodes storing context information in association with at least one user equipment for enabling a continued radio network service for the at least one user equipment when a radio network service shut down is carried out by a serving radio access node;
receiving a request from at least some of the at least one user equipment to provide the continued radio network service, wherein the request comprises an identifier of the serving radio access node;
retrieving, based on the identifier, the context information from at least one of the plurality of radio access nodes; and
providing the continued radio network service to the at least some of the at least one user equipment.

16. The method of claim 15, wherein the information is received from the serving radio access node, or a mobility management function informed of the plurality of radio access nodes by the serving radio access nodes.

17. The method of claim 15, wherein the information is received from the serving radio access node, or a mobility management function informed of the plurality of radio access nodes by the serving radio access nodes, and wherein the radio network service shut down is a determined shut down, and the information that is received comprises an indication of the determined shut down.

18. The method of claim 15, wherein retrieving the context information comprises:
determining to retrieve the context information from the at least one of the plurality of radio access nodes, based on the request and the information that also comprises the identifier of the serving radio access node;
transmitting a request for the context information to the at least one of the plurality of radio access nodes; and
receiving the context information from the at least one of the plurality of radio access nodes, in association with the request for the context information.
